(19) United States
(12) Patent Application Publication
(10) Pub. No.: US 2024/0369838 A1
(43) Pub. Date: Nov. 7, 2024

(54) LENS ASSEMBLY AND ELECTRONIC DEVICE

(71) Applicants: BEIJING BOE DISPLAY TECHNOLOGY CO., LTD., Beijing (CN); BOE Technology Group Co., Ltd., Beijing (CN)

(72) Inventors: Na Han, Beijing (CN); Lili Chen, Beijing (CN); Haitao Huang, Beijing (CN); Ruijun Dong, Beijing (CN)

(73) Assignees: BEIJING BOE DISPLAY TECHNOLOGY CO., LTD., Beijing (CN); BOE Technology Group Co., Ltd., Beijing (CN)

(21) Appl. No.: 18/257,601

(22) PCT Filed: Aug. 4, 2022
(86) PCT No.: PCT/CN2022/110180

§ 371 Date: Jun. 15, 2023

(51) Int. Cl. G02B 27/01; G02B 3/04; G02B 6/42

(52) U.S. Cl. CPC G02B 27/0172; G02B 3/04; G02B 6/4206

(57) ABSTRACT

A lens assembly is provided. The lens assembly includes a display panel and N number of lenses. The N number of lenses includes a first lens having a receiving surface configured to receive image light from the display panel and an N-th lens having an exit surface through which the image light exits, N≥2. On a side where the image light exits the N-th lens, the N-th lens has a length and a width. A ratio of the length to the width is greater than 3:1.

### TECHNICAL FIELD

The present invention relates to display technology, more particularly, to a lens assembly and an electronic device.

### BACKGROUND

Augmented Reality (AR) technology enables the integration of real-world information and virtual world information in display. For example, head-mounted display device utilizes near-eye display technology that allows a user to view their surroundings while viewing a virtual image being displayed, with the virtual image superimposed on the user's perception of the real world. AR display creates a more realistic experience and greater user immersion. In recent years, head-mounted display has become widely used in various applications such as military and aerospace applications.

### SUMMARY

In one aspect, the present disclosure provides a lens assembly, comprising a display panel and N number of lenses; wherein the N number of lenses comprises a first lens having a receiving surface configured to receive image light from the display panel and an N-th lens having an exit surface through which the image light exits, N≥2; wherein, on a side where the image light exits the N-th lens, the N-th lens has a length and a width; and a ratio of the length to the width is greater than 3:1.

Optionally, the exit surface is a first even aspheric surface.

Optionally, the first even aspheric surface satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on the first even aspheric surface to a plane tangent to the first even aspheric surface at a vertex of the even aspheric surface; c stands for a curvature of the even aspheric surface; k stands for a quadratic surface coefficient; r stands for a shortest distance between the respective point on the first even aspheric surface to an optical axis of the lens assembly; and A₂ᵢ stands for a multiple term coefficient.

Optionally, the N-th lens has a second even aspheric surface opposite to the first even aspheric surface.

Optionally, at least one of two opposite surfaces of an (N-1)-th lens is an even aspheric surface.

Optionally, at least one of two opposite surfaces of an (N-2)-th lens is an even aspheric surface.

Optionally, at least one of two opposite surfaces of an (N-3)-th lens is an even aspheric surface.

Optionally, two opposite surfaces of the N-th lens and two opposite surfaces of an (N-1)-th lens are even aspheric surfaces.

Optionally, two opposite surfaces of the N-th lens, two opposite surfaces of an (N-2)-th lens, and two opposite surfaces of an (N-4)-th lens are even aspheric surfaces.

Optionally, two opposite surfaces of the N-th lens, two opposite surfaces of an (N-1)-th lens, two opposite surfaces of an (N-2)-th lens, and two opposite surfaces of an (N-3)-th lens are even aspheric surfaces.

Optionally, at least an (N-3)-th lens is a biconvex lens.

Optionally, an (N-1)-th lens is a biconvex lens.

Optionally, the N-th lens is a biconvex lens.

Optionally, an (N-2) lens and an (N-4)-th lens are biconvex lenses.

Optionally, at least the first lens is a biconcave lens.

Optionally, the first lens is a biconcave lens, an (N-3)-th lens is a biconvex lens, the N-th lens is a convex concave lens, an (N-1)-th lens is a convex concave lens, an (N-2)-th lens is a convex concave lens, and an (N-4)-th lens is a convex concave lens.

Optionally, an (N-1)-th lens is a biconcave lens, an (N-3)-th lens is a biconcave lens, the N-th lens is a convex concave lens, an (N-2)-th lens is a convex concave lens, and the first lens is a convex concave lens.

Optionally, the first lens is a biconcave lens, an (N-2)-th lens is a biconvex lens, an (N-4)-th lens is a biconvex lens, the N-th lens is a convex concave lens, an (N-1)-th lens is a convex concave lens, and an (N-3)-th lens is a convex concave lens.

Optionally, the N-th lens is a biconvex lens, an (N-3)-th lens is a biconvex lens, an (N-1)-th lens is a convex concave lens, an (N-2)-th lens is a convex concave lens, and the first lens is a convex concave lens.

In another aspect, the present disclosure provides an electronic device, comprising the lens assembly described herein, and a waveguide configured to receive the image light exited from the lens assembly.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the structure of a lens assembly in some embodiments according to the present disclosure.

FIG. 2 is a front view of a lens assembly along a light path of image light from a display panel in some embodiments according to the present disclosure.

FIG. 3 is a schematic diagram illustrating the structure of an optical system for augmented reality display in related art.

FIG. 4 is a diagram illustrating the structure of a lens assembly in some embodiments according to the present disclosure.

FIG. 5 illustrates parameters of an even aspheric surface in some embodiments according to the present disclosure.

FIG. 6 illustrates several regions for testing imaging quality of a lens assembly in some embodiments according to the present disclosure.

FIG. 7A to FIG. 7E illustrate ranges of light path corresponding to several regions for testing imaging quality of a lens assembly depicted in FIG. 1.

FIG. 8A to FIG. 8E illustrate modulation transfer functions of several regions for testing imaging quality of a lens assembly depicted in FIG. 1.

FIG. 9A to FIG. 9E are point-column diagrams of several regions for testing imaging quality of a lens assembly depicted in FIG. 1.

FIG. 10 shows aberrations of a lens assembly depicted in FIG. 1.

FIG. 11 is a diagram illustrating the structure of a lens assembly in some embodiments according to the present disclosure.

FIG. 12 is a diagram illustrating the structure of a lens assembly in some embodiments according to the present disclosure.

FIG. 13A to FIG. 13E illustrate ranges of light path corresponding to several regions for testing imaging quality of a lens assembly depicted in FIG. 11.

FIG. 14A to FIG. 14E illustrate modulation transfer functions of several regions for testing imaging quality of a lens assembly depicted in FIG. 11.

FIG. 15A to FIG. 15E are point-column diagrams of several regions for testing imaging quality of a lens assembly depicted in FIG. 11.

FIG. 16 shows aberrations of a lens assembly depicted in FIG. 11.

FIG. 17 is a diagram illustrating the structure of a lens assembly in some embodiments according to the present disclosure.

FIG. 18 is a diagram illustrating the structure of a lens assembly in some embodiments according to the present disclosure.

FIG. 19A to FIG. 19E illustrate ranges of light path corresponding to several regions for testing imaging quality of a lens assembly depicted in FIG. 17.

FIG. 20A to FIG. 20E illustrate modulation transfer functions of several regions for testing imaging quality of a lens assembly depicted in FIG. 17.

FIG. 21A to FIG. 21E are point-column diagrams of several regions for testing imaging quality of a lens assembly depicted in FIG. 17.

FIG. 22 shows aberrations of a lens assembly depicted in FIG. 17.

FIG. 23 is a diagram illustrating the structure of a lens assembly in some embodiments according to the present disclosure.

FIG. 24 is a diagram illustrating the structure of a lens assembly in some embodiments according to the present disclosure.

FIG. 25A to FIG. 25E illustrate ranges of light path corresponding to several regions for testing imaging quality of a lens assembly depicted in FIG. 23.

FIG. 26A to FIG. 26E illustrate modulation transfer functions of several regions for testing imaging quality of a lens assembly depicted in FIG. 23.

FIG. 27A to FIG. 27E are point-column diagrams of several regions for testing imaging quality of a lens assembly depicted in FIG. 23.

FIG. 28 shows aberrations of a lens assembly depicted in FIG. 23.

FIG. 29 is a schematic diagram illustrating the structure of an electronic device in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, a lens assembly and an electronic device that substantially obviate one or more of the problems due to limitations and disadvantages of the related art. In one aspect, the present disclosure provides a lens assembly. In some embodiments, the lens assembly includes a display panel and N number of lenses, N≥2 (e.g., 2, 3, 4, 5, 6, 7, 8, 9, 10, 11, 12, 13, 14, 15, 16, 17, 18, 19, or 20). Optionally, the N number of lenses comprises a first lens having a receiving surface configured to receive image light from the display panel and an N-th lens having an exit surface through which the image light exits. Optionally, on a side where the image light exits the N-th lens, the N-th lens has a length and a width. Optionally, a ratio of the length to the width is greater than 3:1.

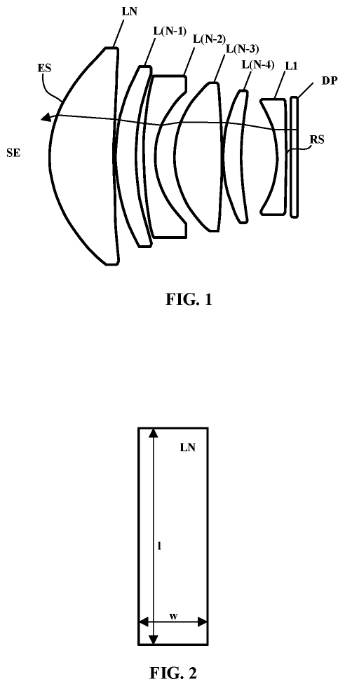

FIG. 1 is a diagram illustrating the structure of a lens assembly in some embodiments according to the present disclosure. Referring to FIG. 1, the lens assembly in some embodiments includes a display panel DP and N number of lenses. The N number of lenses includes a first lens L1, an (N-4)-th lens L(N-4), an (N-3)-th lens L(N-3), an (N-2)-th lens L(N-2), an (N-1)-th lens L(N-1), and an N-th lens LN. As shown in FIG. 1, the N number of lenses includes a first lens LI having a receiving surface RS configured to receive image light from the display panel DP and an N-th lens having an exit surface ES through which the image light exits. In one example, N=6. Optionally, N is a positive integer.

FIG. 2 is a front view of a lens assembly along a light path of image light from a display panel in some embodiments according to the present disclosure. Referring to FIG. 1 and FIG. 2, on a side SE where the image light exits the N-th lens LN, the N-th lens LN has a length l and a width w. Optionally, the length l is greater than the width w. Optionally, a ratio of the length l to the width w is greater than 1:1, e.g., greater than 1.2:1, greater than 1.4:1, greater than 1.6:1, greater than 1.8:1, greater than 2.0:1, greater than 2.2:1, greater than 2.4:1, greater than 2.6:1, greater than 2.8:1, greater than 3.0:1, greater than 3.2:1, greater than 3.4:1, greater than 3.6:1, greater than 3.8:1, greater than 4.0:1, greater than 4.2:1, greater than 4.4:1, greater than 4.6:1, greater than 4.8:1, greater than 5.0:1, greater than 5.2:1, greater than 5.4:1, greater than 5.6:1, greater than 5.8:1, or greater than 6.0:1. Optionally, the ratio of the length 1 to the width w is greater than 3:1. Optionally, the ratio of the length I to the width w is greater than 4:1.

In one example, the length l is approximately 17 mm, and the width w is approximately 5 mm.

As compared to the related lens assembly used for augmented reality display, the lens assembly described in the present disclosure has a relatively large eyebox, as shown in FIG. 1 and FIG. 2. FIG. 3 is a schematic diagram illustrating the structure of an optical system for augmented reality display in related art. Referring to FIG. 3, the optical system includes a lens assembly and a waveguide WG. The lens assembly in the related art includes a lens LS and a display panel DP. The lens LS receives image light from the display panel DP. The image light exits the lens LS and enters into the waveguide WG. The waveguide WG has a first opposing surface OS1 and a second opposing surface OS2 separated by a thickness t of the waveguide WG. The image light entered into the waveguide WG is configured to propagate along the waveguide WG by reflecting off of the first opposing surface OSI and the second opposing surface OS2 using total internal reflection. As shown in FIG. 3, an exit dimension

ED of the image light along a length direction of the waveguide WG (light propagation direction) is determined by the thickness t of the waveguide WG. In the related optical system, the waveguide WG is made to have a relatively large thickness in order to achieve a sufficiently large exit dimension. The related optical system has a relatively small eyebox, and is bulky and heavy. The lens assembly according to the present disclosure obviates these issues.

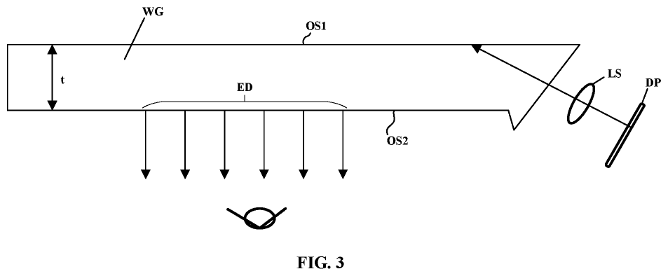

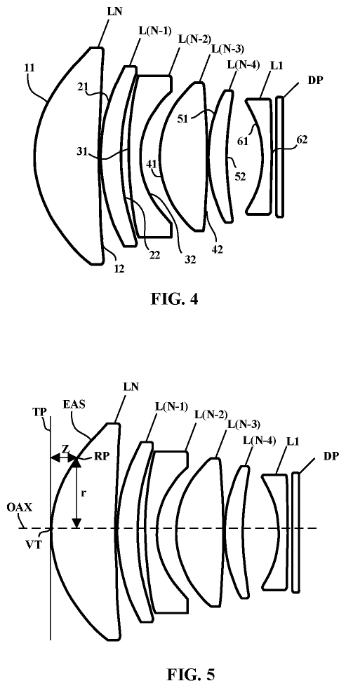

FIG. 4 is a diagram illustrating the structure of a lens assembly in some embodiments according to the present disclosure. The lens assembly depicted in FIG. 4 corresponds to the lens assembly depicted in FIG. 1, with surfaces of the N number of lens annotated. Referring to FIG. 4, the N-th lens LN (e.g., a sixth lens when N=6) has a surface 11 and a surface 12, the surface 11 on a side of the surface 12 away from the display panel DP. The (N-1) lens L(N-1) (e.g., a fifth lens when N=6) has a surface 21 and a surface 22, the surface 21 on a side of the surface 22 away from the display panel DP. The (N-2) lens L(N-2) (e.g., a fourth lens when N=6) has a surface 31 and a surface 32, the surface 31 on a side of the surface 32 away from the display panel DP. The (N-3) lens L(N-3) (e.g., a third lens when N=6) has a surface 41 and a surface 42, the surface 41 on a side of the surface 42 away from the display panel DP. The (N-4) lens L(N-4) (e.g., a second lens when N=6) has a surface 51 and a surface 52, the surface 51 on a side of the surface 52 away from the display panel DP. The first lens L1 has a surface 61 and a surface 62, the surface 61 on a side of the surface 62 away from the display panel DP. Table 1 lists parameters of the lens assembly depicted in FIG. 4. The surface 11 corresponds to the exit surface ES depicted in FIG. 1. The surface 62 corresponds to the receiving surface RS depicted in FIG. 1.

TABLE 1
Parameters of the lens assembly depicted in FIG. 4.
f = 15.5 mm TL = 20.3 mm FOV = 36°

| Surface | R (mm) | T (mm) | k | Refractive index | V-value |
|---|---|---|---|---|---|
| 11 | 10.06 | 5.380 | 1.002 | 1.75 | 52.3 |
| 12 | 122.90 | 0.150 | | | |
| 21 | 15.58 | 1.710 | | 1.65 | 53.2 |
| 22 | 20.47 | 0.700 | | | |
| 31 | 32.42 | 0.980 | | 2.0 | 20.7 |
| 32 | 7.3 | 1.608 | | | |
| 41 | 8.17 | 3.940 | | 1.47 | 66.9 |
| 42 | −63.73 | 0.150 | | | |
| 51 | 12.12 | 1.570 | | 1.81 | 22.7 |
| 52 | 30.18 | 2.960 | | | |
| 61 | −8.57 | 0.730 | | 1.53 | 64.2 |
| 62 | −135.29 | 0.450 | | | |

In Table 1, f stands for a focal length of the lens assembly; TL stands for a total length of the lens assembly; FOV stands for a diagonal field of view for the lens assembly; R stands for a radius of curvature of an individual lens in the lens assembly; T stands for a thickness of an individual lens in the lens assembly; V-value stands for Abbe number, a measurement of dispersion or color distortion of an individual lens; and k stands for a quadratic surface coefficient when an individual surface is an even aspheric surface.

In some embodiments, at least one surface of the lens assembly is an aspheric surface, e.g., an even aspheric surface. By having an aspheric surface in the lens assembly, the spherical aberration, coma, field curvature, and many other aberrations of the optical system can be reduced.

In some embodiments, the exit surface (e.g., the surface 11 in FIG. 4) is a first even aspheric surface. In some embodiments, the first even aspheric surface satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on the first even aspheric surface to a plane tangent to the first even aspheric surface at a vertex of the first even aspheric surface; c stands for a curvature of the first even aspheric surface; k stands for a quadratic surface coefficient; r stands for a shortest distance between the respective point on the first even aspheric surface to an optical axis of the lens assembly; A₂ᵢ stands for a multiple term coefficient.

FIG. 5 illustrates parameters of an even aspheric surface in some embodiments according to the present disclosure. Referring to FIG. 5, Z stands for a shortest distance between a respective point RP on the first even aspheric surface EAS to a plane TP tangent to the first even aspheric surface EAS at a vertex VT of the even aspheric surface EAS; r stands for a shortest distance between the respective point RP on the first even aspheric surface EAS to an optical axis OAX of the lens assembly.

In one example, the multiple term coefficient A₂ᵢ for the surface 11 includes A₄ (5.776×10⁻⁵), A₆ (−1.855×10⁻⁷), and A₈ (3.375×10⁻¹⁰).

In one example, the display panel DP is an organic light emitting diode display panel having a width of 0.39 inch, a resolution of 1920×1080 ppi. In another example, an individual pixel of the display panel DP has a width of 4.6 μm, with a limiting resolution of 108 lp/mm.

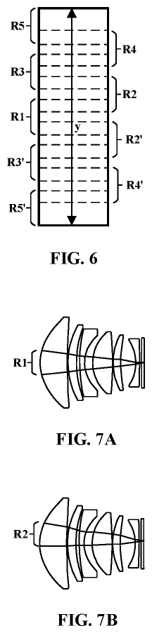

Imagining quality of the lens assembly may be tested region-by-region. FIG. 6 illustrates several regions for testing imaging quality of a lens assembly in some embodiments according to the present disclosure. Referring to FIG. 6, in one example, imaging quality of the lens assembly may be tested in regions R1, R2, R3, R4, R5, R2′, R3′, R4′, and R5′. Ranges of y-coordinates of these regions are listed in Table 2.

TABLE 2
Ranges of y-coordinates of several regions for
testing imaging quality of a lens assembly.

| Region | y coordinate |
|---|---|
| R1 | 0 ± 2.5 mm |
| R2 | 1.771 ± 2.5 mm |
| R3 | 2.954 ± 2.5 mm |
| R4 | 4.181 ± 2.5 mm |
| R5 | 5.927 ± 2.5 mm |
| R2′ | −1.771 ± 2.5 mm |
| R3′ | −2.954 ± 2.5 mm |
| R4′ | −4.181 ± 2.5 mm |
| R5′ | −5.927 ± 2.5 mm |

Imaging quality of the R2′ region is similar to image quality of the R2 region. Imaging quality of the R3′ region is similar to image quality of the R3 region. Imaging quality of the R4′ region is similar to image quality of the R4 region. Imaging quality of the R5′ region is similar to image quality of the R5 region.

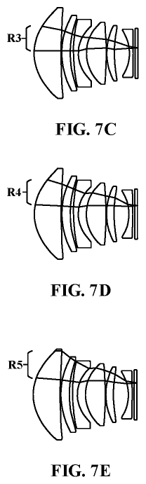

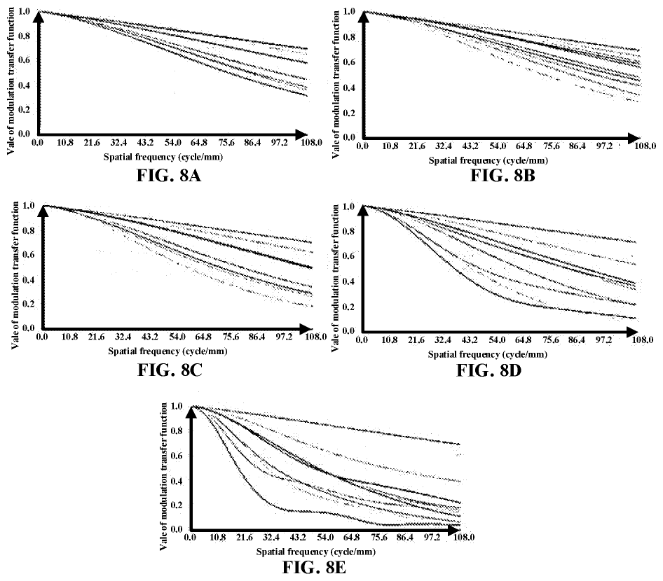

FIG. 7A to FIG. 7E illustrate ranges of light path corresponding to several regions for testing imaging quality of a lens assembly depicted in FIG. 1. Referring to FIG. 7A to FIG. 7E, ranges of light path corresponding to regions R1, R2, R3, R4, and R5 are illustrated. FIG. 8A to FIG. 8E illustrate modulation transfer functions of several regions for testing imaging quality of a lens assembly depicted in FIG. 1. FIG. 8A to FIG. 8E depict the modulation transfer functions of regions R1, R2, R3, R4, and R5, respectively. The values of modulation transfer functions indicate imaging quality of an optical system. In general, the smoother the shape of the curve of the modulation transfer function and the higher the values of the modulation transfer function, the better the imaging quality. As shown in FIG. 8A to FIG. 8E, the value of modulation transfer function of the region R1 at a spatial frequency of 108 lp/mm is greater than 0.3, the values of modulation transfer functions of the regions R2 and R3 at a spatial frequency of 108 lp/mm are greater than 0.19, and the value of modulation transfer function of the region R4 at a spatial frequency of 108 lp/mm is greater than 0.1. The present lens assembly obviates imaging aberrations, achieving excellent imaging quality.

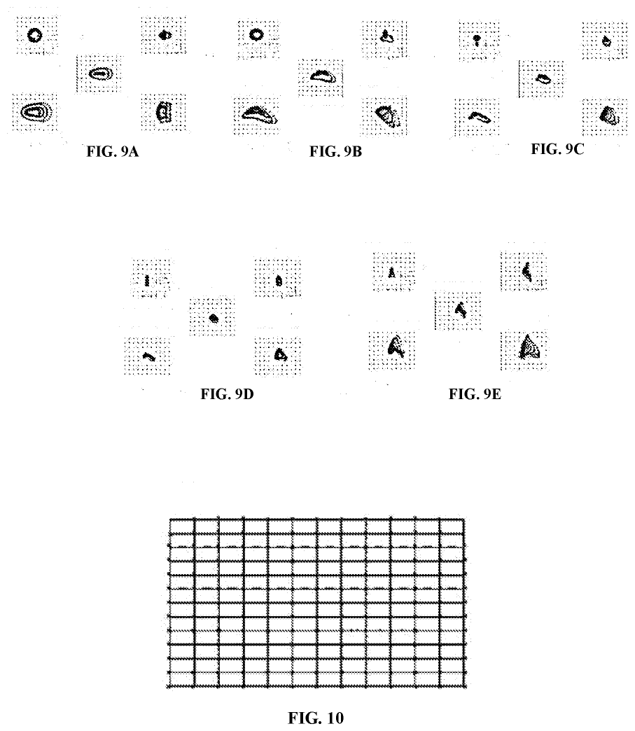

FIG. 9A to FIG. 9E are point-column diagrams of several regions for testing imaging quality of a lens assembly depicted in FIG. 1. A point-column diagram indicates the imaging geometry of an optical system. The degree of denseness of the points in a point-column diagram is a visual indication of the imaging quality of an optical system. The smaller the root-mean-square (RMS) radius of the point-column diagram, the smaller the aberration and the better the imaging quality of an optical system. Referring to FIG. 9A to FIG. 9E, the maximum RMS radius is below 15.1 μm, indicating a spot in an individual field of view is relatively small, imaging aberrations are well obviated, and the imaging quality of the lens assembly is excellent.

FIG. 10 shows aberrations of a lens assembly depicted in FIG. 1. Referring to FIG. 10, the maximum aberration of the lens assembly is 1.013%.

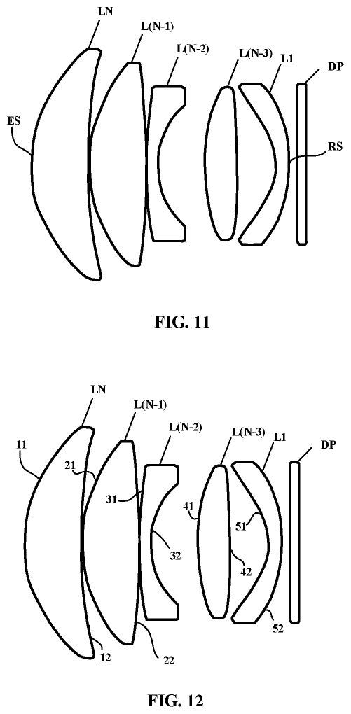

FIG. 11 is a diagram illustrating the structure of a lens assembly in some embodiments according to the present disclosure. Referring to FIG. 11, the lens assembly in some embodiments includes a display panel DP and N number of lenses. The N number of lenses includes a first lens L1, an (N-3)-th lens L(N-3), an (N-2)-th lens L(N-2), an (N-1)-th lens L(N-1), and an N-th lens LN. As shown in FIG. 11, the N number of lenses includes a first lens L1 having a receiving surface RS configured to receive image light from the display panel DP and an N-th lens having an exit surface ES through which the image light exits. In one example, N=5.

FIG. 12 is a diagram illustrating the structure of a lens assembly in some

embodiments according to the present disclosure. The lens assembly depicted in FIG. 12 corresponds to the lens assembly depicted in FIG. 11, with surfaces of the N number of lens annotated. Referring to FIG. 12, the N-th lens LN (e.g., a fifth lens when N=5) has a surface 11 and a surface 12, the surface 11 on a side of the surface 12 away from the display panel DP. The (N-1) lens L(N-1) (e.g., a fourth lens when N=5) has a surface 21 and a surface 22, the surface 21 on a side of the surface 22 away from the display panel DP. The (N-2) lens L(N-2) (e.g., a third lens when N=5) has a surface 31 and a surface 32, the surface 31 on a side of the surface 32 away from the display panel DP. The (N-3) lens L(N-3) (e.g., a second lens when N=5) has a surface 41 and a surface 42, the surface 41 on a side of the surface 42 away from the display panel DP. The first lens L1 has a surface 51 and a surface 52, the surface 51 on a side of the surface 52 away from the display panel DP. Table 3 lists parameters of the lens assembly depicted in FIG. 12. The surface 11 corresponds to the exit surface ES depicted in FIG. 11. The surface 52 corresponds to the receiving surface RS depicted in FIG. 11.

TABLE 3
Parameters of the lens assembly depicted in FIG. 12.
f = 19.76 mm TL = 21.2 mm FOV = 36°

| Surface | R (mm) | T (mm) | k | Refractive index | V-value |
|---|---|---|---|---|---|
| 11 | 10.82 | 4.471 | −1.086 | 1.75 | 52.3 |
| 12 | 53.54 | 0.183 | 26.900 | | |
| 21 | 12.43 | 4.369 | | 1.52 | 64.0 |
| 22 | −63.29 | 0.166 | | | |
| 31 | 59.71 | 0.841 | 69.264 | 2.0 | 20.7 |
| 32 | 7.15 | 3.762 | 0.648 | | |
| 41 | 15.25 | 2.489 | | 1.81 | 22.7 |
| 42 | −58.69 | 3.062 | | | |
| 51 | −4.51 | 1.059 | −2.246 | 1.58 | 53.7 |
| 52 | −11.61 | 0.806 | 0.5778 | | |

In Table 3, f stands for a focal length of the lens assembly; TL stands for a total length of the lens assembly; FOV stands for a diagonal field of view for the lens assembly; R stands for a radius of curvature of an individual lens in the lens assembly; T stands for a thickness of an individual lens in the lens assembly; V-value stands for Abbe number, a measurement of dispersion or color distortion of an individual lens; and k stands for a quadratic surface coefficient when an individual surface is an even aspheric surface.

In some embodiments, at least one surface of the lens assembly is an aspheric surface, e.g., an even aspheric surface. By having an aspheric surface in the lens assembly, the spherical aberration, coma, field curvature, and many other aberrations of the optical system can be reduced.

In some embodiments, the N-th lens has a first even aspheric surface (e.g., the surface 11 in FIG. 12) and a second even aspheric surface (e.g., the surface 12 in FIG. 12) opposite to the first even aspheric surface. In some embodiments, the first even aspheric surface or the second even aspheric surface satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on an individual even aspheric surface to a plane tangent to the individual even aspheric surface at a vertex of the individual even aspheric surface; c stands for a curvature of the individual even aspheric surface; k stands for a quadratic surface coefficient; r stands for a shortest distance between the respective point on the individual even aspheric surface to an optical axis of the lens assembly; A₂ᵢ stands for a multiple term coefficient.

In some embodiments, at least one of two opposite surfaces of an (N-2)-th lens is an even aspheric surface. Optionally, both of the two opposite surfaces of an (N-2)-th lens are even aspheric surfaces.

In some embodiments, at least one of two opposite surfaces of the first lens is an even aspheric surface. Optionally, both of the two opposite surfaces of the first lens are even aspheric surfaces.

In some embodiments, the surfaces 11, 12, 31, 32, 51, and 52 of the lens assembly are even aspheric surfaces that satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on an individual even aspheric surface to a plane tangent to the individual even aspheric surface at a vertex of the individual even aspheric surface; c stands for a curvature of the individual even aspheric surface; k stands for a quadratic surface coefficient; r stands for a shortest distance between the respective point on the individual even aspheric surface to an optical axis of the lens assembly; A₂ᵢ stands for a multiple term coefficient. Table 4 lists multiple term coefficients of these even aspheric surfaces.

TABLE 4
Multiple term coefficients of even aspheric surfaces
in a lens assembly depicted in FIG. 12.
Multiple term coefficients

| Surface | A₄ | A₆ | A₈ |
|---|---|---|---|
| 11 | 7.400 × 10⁻⁵ | 2.461 × 10⁻⁷ | 9.251 × 10⁻¹⁰ |
| 12 | 0 | 0 | 0 |
| 31 | 0 | 0 | 0 |
| 32 | 0 | 0 | 0 |
| 51 | 0 | 0 | 0 |
| 52 | 0 | 0 | 0 |

In one example, the display panel DP is an organic light emitting diode display panel having a width of 0.49 inch, a resolution of 1920×1080 ppi. In another example, an individual pixel of the display panel DP has a width of 5.8 μm, with a limiting resolution of 86 lp/mm.

Imagining quality of the lens assembly may be tested region-by-region. Referring to FIG. 6, in one example, imaging quality of the lens assembly depicted in FIG. 11 may be tested in regions R1, R2, R3, R4, R5, R2′, R3′, R4′, and R5′. Ranges of y-coordinates of these regions are listed in Table 5.

TABLE 5
Ranges of y-coordinates of several regions for
testing imaging quality of a lens assembly.

| Region | y coordinate |
|---|---|
| R1 | 0 ± 2.5 mm |
| R2 | 1.771 ± 2.5 mm |
| R3 | 2.954 ± 2.5 mm |
| R4 | 4.181 ± 2.5 mm |
| R5 | 5.927 ± 2.5 mm |
| R2′ | −1.771 ± 2.5 mm |
| R3′ | −2.954 ± 2.5 mm |
| R4′ | −4.181 ± 2.5 mm |
| R5′ | −5.927 ± 2.5 mm |

Imaging quality of the R2′ region is similar to image quality of the R2 region. Imaging quality of the R3′ region is similar to image quality of the R3 region. Imaging quality of the R4′ region is similar to image quality of the R4 region. Imaging quality of the R5′ region is similar to image quality of the R5 region. In some embodiments, on a side where the image light exits the N-th lens LN, the N-th lens LN has a length l and a width w. In one example, the length l is approximately 17 mm, and the width w is approximately 5 mm.

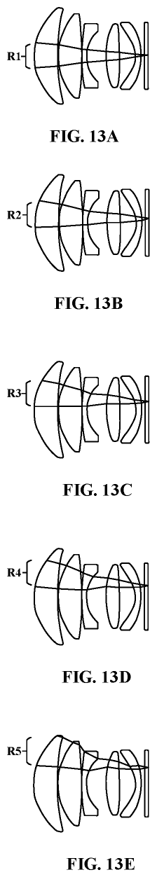

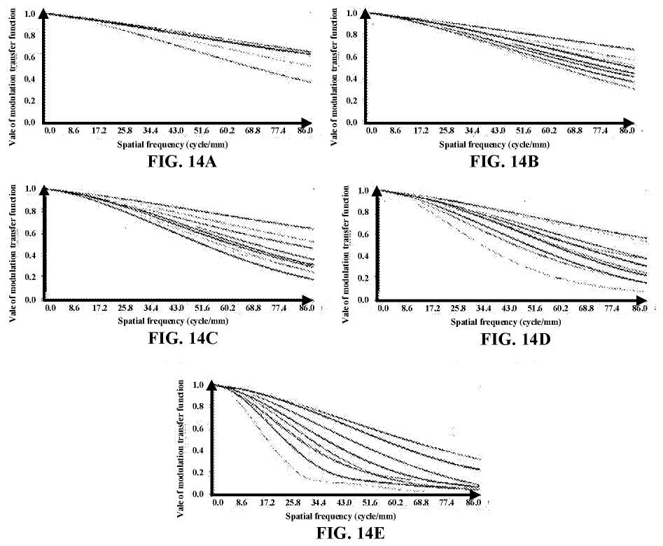

FIG. 13A to FIG. 13E illustrate ranges of light path corresponding to several regions for testing imaging quality of a lens assembly depicted in FIG. 11. Referring to FIG. 13A to FIG. 13E, ranges of light path corresponding to regions R1, R2, R3, R4, and R5 are illustrated. FIG. 14A to FIG. 14E illustrate modulation transfer functions of several regions for testing imaging quality of a lens assembly depicted in FIG. 11. FIG. 14A to FIG. 14E depict the modulation transfer functions of regions R1, R2, R3, R4, and R5, respectively. As shown in FIG. 14A to FIG. 14E, the value of modulation transfer function of the region RI at a spatial frequency of 86 lp/mm is greater than 0.37, the value of modulation transfer function of the region R2 at a spatial frequency of 86 lp/mm is greater than 0.3, the value of modulation transfer function of the region R3 at a spatial frequency of 86 lp/mm is greater than 0.2, and the value of modulation transfer function of the region R4 at a spatial frequency of 86 lp/mm is greater than 0.1. The present lens assembly obviates imaging aberrations, achieving excellent imaging quality.

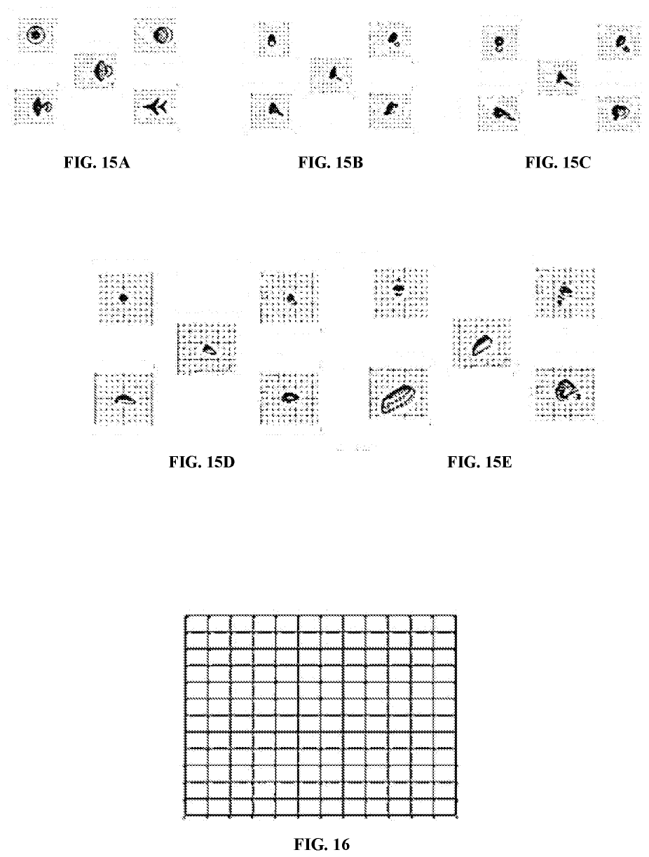

FIG. 15A to FIG. 15E are point-column diagrams of several regions for testing imaging quality of a lens assembly depicted in FIG. 11. Referring to FIG. 15A to FIG. 15E, the maximum RMS radius is below 14.769 μm, indicating a spot in an individual field of view is relatively small, imaging aberrations are well obviated, and the imaging quality of the lens assembly is excellent.

FIG. 16 shows aberrations of a lens assembly depicted in FIG. 11. Referring to FIG. 16, the maximum aberration of the lens assembly is 2.22%.

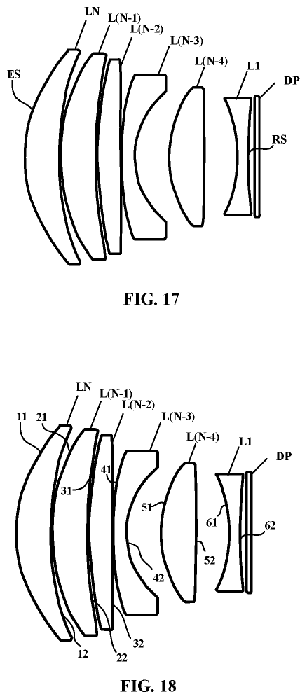

FIG. 17 is a diagram illustrating the structure of a lens assembly in some embodiments according to the present disclosure. Referring to FIG. 17, the lens assembly in some embodiments includes a display panel DP and N number of lenses. The N number of lenses includes a first lens L1, an (N-4)-th lens L(N-4), an (N-3)-th lens L(N-3), an (N-2)-th lens L(N-2), an (N-1)-th lens L(N-1), and an N-th lens LN. As shown in FIG. 17, the N number of lenses includes a first lens LI having a receiving surface RS configured to receive image light from the display panel DP and an N-th lens having an exit surface ES through which the image light exits. In one example, N=6.

FIG. 18 is a diagram illustrating the structure of a lens assembly in some embodiments according to the present disclosure. The lens assembly depicted in FIG. 18 corresponds to the lens assembly depicted in FIG. 17, with surfaces of the N number of lens annotated. Referring to FIG. 18, the N-th lens LN (e.g., a sixth lens when N=6) has a surface 11 and a surface 12, the surface 11 on a side of the surface 12 away from the display panel DP. The (N-1) lens L(N-1) (e.g., a fifth lens when N=6) has a surface 21 and a surface 22, the surface 21 on a side of the surface 22 away from the display panel DP. The (N-2) lens L(N-2) (e.g., a fourth lens when N=6) has a surface 31 and a surface 32, the surface 31 on a side of the surface 32 away from the display panel DP. The (N-3) lens L(N-3) (e.g., a third lens when N=6) has a surface 41 and a surface 42, the surface 41 on a side of the surface 42 away from the display panel DP. The (N-4) lens L(N-4) (e.g., a second lens when N=6) has a surface 51 and a surface 52, the surface 51 on a side of the surface 52 away from the display panel DP. The first lens LI has a surface 61 and a surface 62, the surface 61 on a side of the surface 62 away from the display panel DP. Table 6 lists parameters of the lens assembly depicted in FIG. 18. The surface 11 corresponds to the exit surface ES depicted in FIG. 1. The surface 62 corresponds to the receiving surface RS depicted in FIG. 1.

TABLE 6
Parameters of the lens assembly depicted in FIG. 18.
f = 18.3 mm TL = 24.9 mm FOV = 40°

| Surface | R (mm) | T (mm) | k | Refractive index | V-value |
|---|---|---|---|---|---|
| 11 | 14.452 | 3.802 | −0.875 | 1.82 | 46.6 |
| 12 | 38.193 | 0.195 | 7.414 | | |
| 21 | 23.216 | 3.768 | 1.897 | 1.75 | 52.3 |
| 22 | 61.402 | 0.150 | −2.198 | | |
| 31 | 44.719 | 2.443 | | 1.75 | 52.3 |
| 32 | −5609.227 | 0.135 | | | |
| 41 | 29.977 | 1.479 | | 1.95 | 17.9 |
| 42 | 9.039 | 3.766 | | | |
| 51 | 12.691 | 3.668 | | 1.80 | 42.3 |
| 52 | −286.045 | 3.659 | | | |
| 61 | −15.082 | 1.154 | | 1.65 | 39.5 |
| 62 | 59.235 | 0.702 | | | |

In Table 6, f stands for a focal length of the lens assembly; TL stands for a total length of the lens assembly; FOV stands for a diagonal field of view for the lens assembly; R stands for a radius of curvature of an individual lens in the lens assembly; T stands for a thickness of an individual lens in the lens assembly; V-value stands for Abbe number, a measurement of dispersion or color distortion of an individual lens; and k stands for a quadratic surface coefficient when an individual surface is an even aspheric surface.

In some embodiments, at least one surface of the lens assembly is an aspheric surface, e.g., an even aspheric surface. By having an aspheric surface in the lens assembly, the spherical aberration, coma, field curvature, and many other aberrations of the optical system can be reduced.

In some embodiments, the N-th lens has a first even aspheric surface (e.g., the surface 17 in FIG. 18) and a second even aspheric surface (e.g., the surface 12 in FIG. 18) opposite to the first even aspheric surface. In some embodiments, the first even aspheric surface or the second even aspheric surface satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on an individual even aspheric surface to a plane tangent to the individual even aspheric surface at a vertex of the individual even aspheric surface; c stands for a curvature of the individual even aspheric surface; k stands for a quadratic surface coefficient; r stands for a shortest distance between the respective point on the individual even aspheric surface to an optical axis of the lens assembly; A₂ᵢ stands for a multiple term coefficient.

In some embodiments, at least one of two opposite surfaces of an (N-1)-th lens is an even aspheric surface. Optionally, both of the two opposite surfaces of an (N-1)-th lens are even aspheric surfaces.

In some embodiments, the surfaces 11, 12, 21, and 22 of the lens assembly are even aspheric surfaces that satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on an individual even aspheric surface to a plane tangent to the individual even aspheric surface at a vertex of the individual even aspheric surface; c stands for a curvature of the individual even aspheric surface; k stands for a quadratic surface coefficient; r stands for a shortest distance between the respective point on the individual even aspheric surface to an optical axis of the lens assembly; A₂ᵢ stands for a multiple term coefficient. Table 7 lists multiple term coefficients of these even aspheric surfaces. In one example, A₂ᵢ=0.

In one example, the display panel DP is an organic light emitting diode display panel having a width of 0.50 inch, a resolution of 1600×1200 ppi. In another example, an individual pixel of the display panel DP has a width of 6.5 μm, with a limiting resolution of 77 lp/mm.

Imagining quality of the lens assembly may be tested region-by-region. Referring to FIG. 6, in one example, imaging quality of the lens assembly depicted in FIG. 11 may be tested in regions R1, R2, R3, R4, R5, R2′, R3′, R4′, and R5′. Ranges of y-coordinates of these regions are listed in Table 7.

TABLE 7
Ranges of y-coordinates of several regions for
testing imaging quality of a lens assembly.

| Region | y coordinate |
|---|---|
| R1 | 0 ± 2.5 mm |
| R2 | 2.388 ± 2.5 mm |
| R3 | 3.985 ± 2.5 mm |
| R4 | 5.645 ± 2.5 mm |
| R5 | 8.017 ± 2.5 mm |
| R2′ | −2.388 ± 2.5 mm |
| R3′ | −3.985 ± 2.5 mm |
| R4′ | −5.645 ± 2.5 mm |
| R5′ | −8.017 ± 2.5 mm |

Imaging quality of the R2′ region is similar to image quality of the R2 region. Imaging quality of the R3′ region is similar to image quality of the R3 region. Imaging quality of the R4′ region is similar to image quality of the R4 region. Imaging quality of the R5′ region is similar to image quality of the R5 region. In some embodiments, on a side where the image light exits the N-th lens LN, the N-th lens LN has a length l and a width w. In one example, the length l is approximately 21 mm, and the width w is approximately 5 mm.

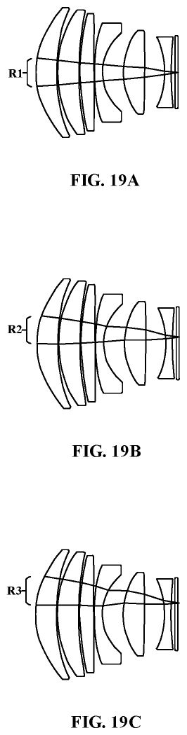

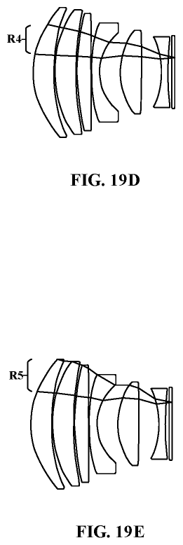

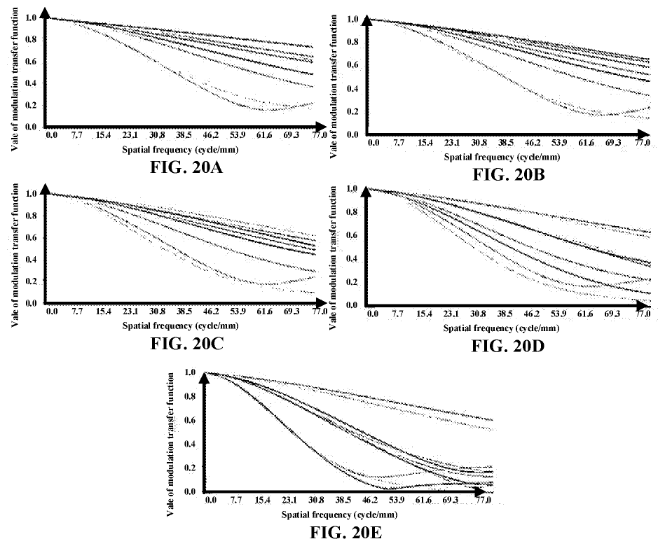

FIG. 19A to FIG. 19E illustrate ranges of light path corresponding to several regions for testing imaging quality of a lens assembly depicted in FIG. 17. Referring to 19A to FIG. 19E, ranges of light path corresponding to regions R1, R2, R3, R4, and R5 are illustrated. FIG. 20A to FIG. 20E illustrate modulation transfer functions of several regions for testing imaging quality of a lens assembly depicted in FIG. 17. FIG. 20A to FIG. 20E depict the modulation transfer functions of regions R1, R2, R3, R4, and R5, respectively. As shown in FIG. 20A to FIG. 20E, the value of modulation transfer function of the region R1 at a spatial frequency of 77 lp/mm is greater than 0.3, the value of modulation transfer functions of the region R2 at a spatial frequency of 77 lp/mm is greater than 0.2, the value of modulation transfer functions of the region R3 at a spatial frequency of 77 lp/mm is greater than 0.14, and the value of modulation transfer function of the region R4 at a spatial frequency of 77 lp/mm is greater than 0.1. The present lens assembly obviates imaging aberrations, achieving excellent imaging quality.

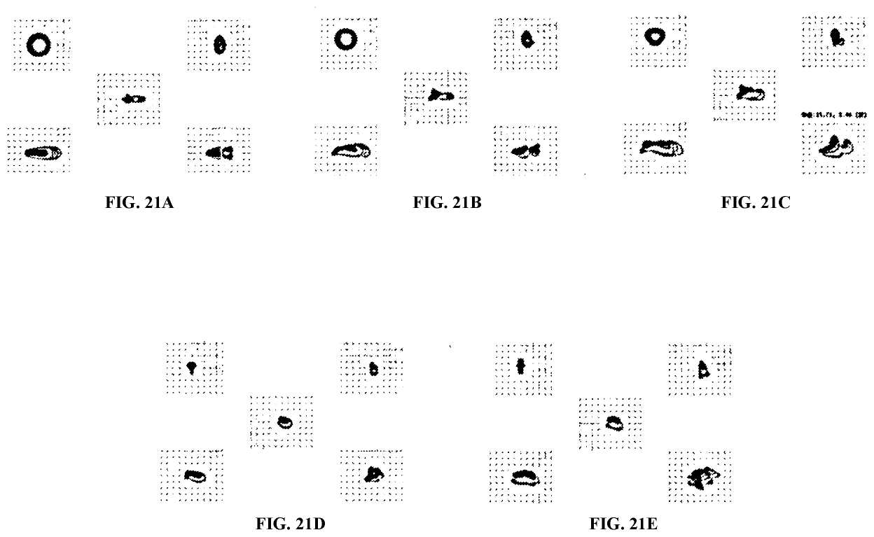

FIG. 21A to FIG. 21E are point-column diagrams of several regions for testing imaging quality of a lens assembly depicted in FIG. 17. Referring to FIG. 21A to FIG. 21E, the maximum RMS radius is below 12.4 μm, indicating a spot in an individual field of view is relatively small, imaging aberrations are well obviated, and the imaging quality of the lens assembly is excellent.

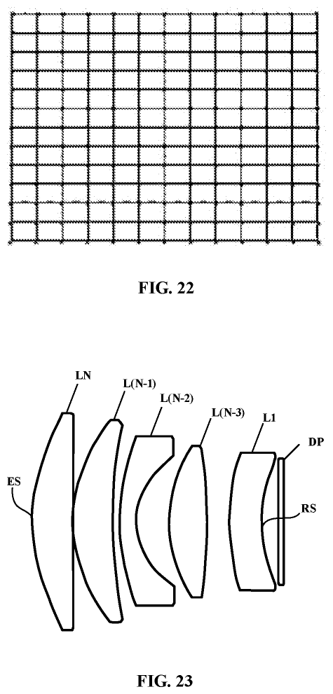

FIG. 22 shows aberrations of a lens assembly depicted in FIG. 17. Referring to FIG. 22, the maximum aberration of the lens assembly is 1.4%.

FIG. 23 is a diagram illustrating the structure of a lens assembly in some embodiments according to the present disclosure. Referring to FIG. 11, the lens assembly in some embodiments includes a display panel DP and N number of lenses. The N number of lenses includes a first lens L1, an (N-3)-th lens L(N-3), an (N-2)-th lens L(N-2), an (N-1)-th lens L(N-1), and an N-th lens LN. As shown in FIG. 23, the N number of lenses includes a first lens L1 having a receiving surface RS configured to receive image light from the display panel DP and an N-th lens having an exit surface ES through which the image light exits. In one example, N=5.

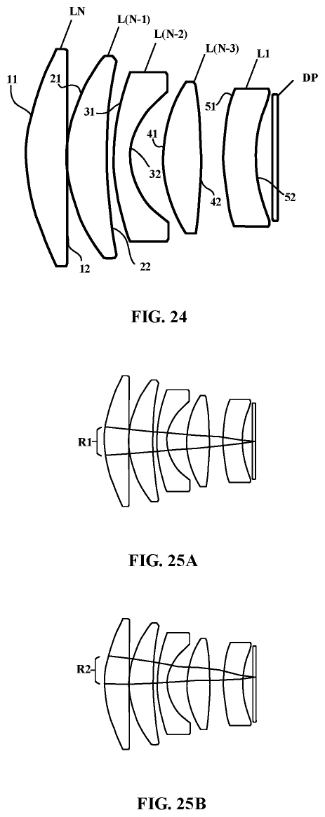

FIG. 24 is a diagram illustrating the structure of a lens assembly in some embodiments according to the present disclosure. The lens assembly depicted in FIG. 24 corresponds to the lens assembly depicted in FIG. 23, with surfaces of the N number of lens annotated. Referring to FIG. 24, the N-th lens LN (e.g., a fifth lens when N=5) has a surface 11 and a surface 12, the surface 11 on a side of the surface 12 away from the display panel DP. The (N-1) lens L(N-1) (e.g., a fourth lens when N=5) has a surface 21 and a surface 22, the surface 21 on a side of the surface 22 away from the display panel DP. The (N-2) lens L(N-2) (e.g., a third lens when N=5) has a surface 31 and a surface 32, the surface 31 on a side of the surface 32 away from the display panel DP. The (N-3) lens L(N-3) (e.g., a second lens when N=5) has a surface 41 and a surface 42, the surface 41 on a side of the surface 42 away from the display panel DP. The first lens L1 has a surface 51 and a surface 52, the surface 51 on a side of the surface 52 away from the display panel DP. Table 8 lists parameters of the lens assembly depicted in FIG. 12. The surface 11 corresponds to the exit surface ES depicted in FIG. 23. The surface 52 corresponds to the receiving surface RS depicted in FIG. 23.

TABLE 8
Parameters of the lens assembly depicted in FIG. 24.
f = 18.3 mm TL = 25.1 mm FOV = 40°

| Surface | R (mm) | T (mm) | k | Refractive index | V-value |
|---|---|---|---|---|---|
| 11 | 19.09 | 4.018 | −0.6970 | 1.82 | 46.6 |
| 12 | 1416.51 | 0.195 | −90.000 | | |
| 21 | 14.35 | 4.033 | −1.455 | 1.75 | 52.3 |
| 22 | 46.74 | 0.759 | −90.000 | | |
| 31 | 21.21 | 1.635 | −55.424 | 1.95 | 17.9 |
| 32 | 6.17 | 3.574 | −1.022 | | |
| 41 | 13.57 | 3.712 | 0.9626 | 1.75 | 52.3 |
| 42 | −40.98 | 2.528 | −90.000 | | |
| 51 | 27.79 | 3.202 | | 1.52 | 64.2 |
| 52 | 15.88 | 1.671 | | | |

In Table 8, f stands for a focal length of the lens assembly; TL stands for a total length of the lens assembly; FOV stands for a diagonal field of view for the lens assembly; R stands for a radius of curvature of an individual lens in the lens assembly; T stands for a thickness of an individual lens in the lens assembly; V-value stands for Abbe number, a measurement of dispersion or color distortion of an individual lens; and k stands for a quadratic surface coefficient when an individual surface is an even aspheric surface.

In some embodiments, at least one surface of the lens assembly is an aspheric surface, e.g., an even aspheric surface. By having an aspheric surface in the lens assembly, the spherical aberration, coma, field curvature, and many other aberrations of the optical system can be reduced.

In some embodiments, the N-th lens has a first even aspheric surface (e.g., the surface 23 in FIG. 24) and a second even aspheric surface (e.g., the surface 12 in FIG. 24) opposite to the first even aspheric surface. In some embodiments, the first even aspheric surface or the second even aspheric surface satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on an individual even aspheric surface to a plane tangent to the individual even aspheric surface at a vertex of the individual even aspheric surface; c stands for a curvature of the individual even aspheric surface; k stands for a quadratic surface coefficient; r stands for a shortest distance between the respective point on the individual even aspheric surface to an optical axis of the lens assembly; A₂ᵢ stands for a multiple term coefficient.

In some embodiments, at least one of two opposite surfaces of an (N-1)-th lens is an even aspheric surface. Optionally, both of the two opposite surfaces of an (N-1)-th lens are even aspheric surfaces.

In some embodiments, at least one of two opposite surfaces of an (N-2)-th lens is an even aspheric surface. Optionally, both of the two opposite surfaces of an (N-2)-th lens are even aspheric surfaces.

In some embodiments, at least one of two opposite surfaces of an (N-3)-th lens is an even aspheric surface. Optionally, both of the two opposite surfaces of an (N-3)-th lens are even aspheric surfaces.

In some embodiments, the surfaces 11, 12, 21, 22, 31, 32, 41, and 42 of the lens assembly are even aspheric surfaces that satisfies the following function:

$$Z = \frac{{cr}^{2}}{1 + \sqrt{1 - ( k + 1 ) {c}^{2} {r}^{2}}} + {Σ}_{i} {A}_{2 i} {r}^{2 i} ;$$

wherein Z stands for a shortest distance between a respective point on an individual even aspheric surface to a plane tangent to the individual even aspheric surface at a vertex of the individual even aspheric surface; c stands for a curvature of the individual even aspheric surface; k stands for a quadratic surface coefficient; r stands for a shortest distance between the respective point on the individual even aspheric surface to an optical axis of the lens assembly; A₂ᵢ stands for a multiple term coefficient. Table 9 lists multiple term coefficients of these even aspheric surfaces.

TABLE 9
Multiple term coefficients of even aspheric surfaces
in a lens assembly depicted in FIG. 24.
Multiple term coefficients

| Surface | A₄ | A₆ | A₈ |
|---|---|---|---|
| 11 | 3.74 × 10⁻⁷ | −1.61 × 10⁻⁷ | 0 |
| 12 | 0 | 0 | 0 |
| 21 | −5.810 × 10⁻⁵ | 8.302 × 10⁻⁷ | −1.824 × 10⁻⁹ |
| 22 | 1.127 × 10⁻⁴ | −1.32 × 10⁻⁶ | 3.842 × 10⁻⁹ |
| 31 | 8.832 × 10⁻⁶ | −5.93 × 10⁻⁷ | 0 |
| 32 | −8.216 × 10⁻⁵ | 2.965 × 10⁻⁶ | 1.131 × 10⁻⁸ |
| 41 | −1.564 × 10⁻⁴ | 2.238 × 10⁻⁷ | −4.035 × 10⁻⁹ |
| 42 | 0 | 0 | 0 |

In one example, the display panel DP is an organic light emitting diode display panel having a width of 0.50 inch, a resolution of 1600×1200 ppi. In another example, an individual pixel of the display panel DP has a width of 6.5 μm, with a limiting resolution of 77 lp/mm.

Imagining quality of the lens assembly may be tested region-by-region. Referring to FIG. 6, in one example, imaging quality of the lens assembly depicted in FIG. 23 may be tested in regions R1, R2, R3, R4, R5, R2′, R3′, R4′, and R5′. Ranges of y-coordinates of these regions are listed in Table 10.

TABLE 10
Ranges of y-coordinates of several regions for
testing imaging quality of a lens assembly.

| Region | y coordinate |
|---|---|
| R1 | 0 ± 2.5 mm |
| R2 | 2.388 ± 2.5 mm |
| R3 | 3.985 ± 2.5 mm |
| R4 | 5.645 ± 2.5 mm |
| R5 | 8.017 ± 2.5 mm |
| R2′ | −2.388 ± 2.5 mm |
| R3′ | −3.985 ± 2.5 mm |
| R4′ | −5.645 ± 2.5 mm |
| R5′ | −8.017 ± 2.5 mm |

Imaging quality of the R2′ region is similar to image quality of the R2 region. Imaging quality of the R3′ region is similar to image quality of the R3 region. Imaging quality of the R4′ region is similar to image quality of the R4 region. Imaging quality of the R5′ region is similar to image quality of the R5 region. In some embodiments, on a side where the image light exits the N-th lens LN, the N-th lens LN has a length l and a width w. In one example, the length l is approximately 21 mm, and the width w is approximately 5 mm.

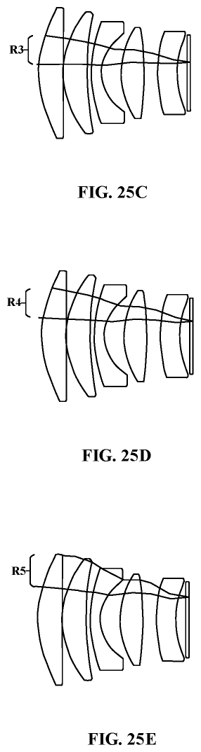

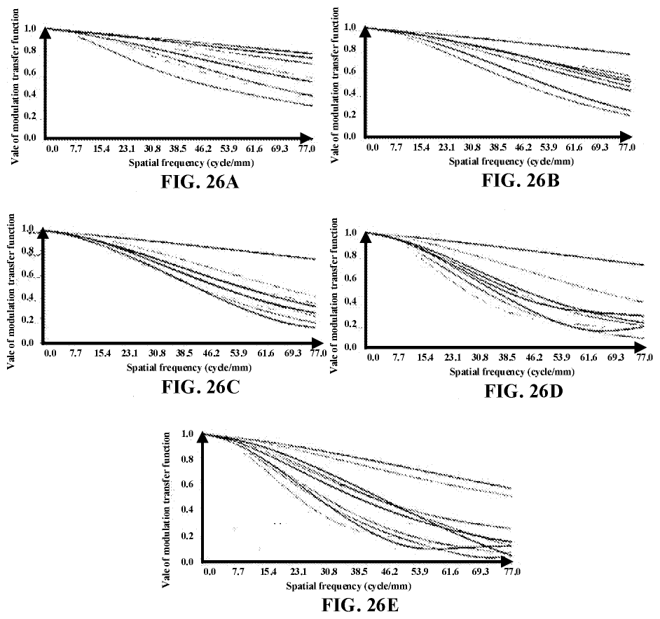

FIG. 25A to FIG. 25E illustrate ranges of light path corresponding to several regions for testing imaging quality of a lens assembly depicted in FIG. 23. Referring to FIG. 25A to FIG. 25E, ranges of light path corresponding to regions R1, R2, R3, R4, and R5 are illustrated. FIG. 26A to FIG. 26E illustrate modulation transfer functions of several regions for testing imaging quality of a lens assembly depicted in FIG. 23. FIG. 26A to FIG. 26E depict the modulation transfer functions of regions R1, R2, R3, R4, and R5, respectively. As shown in FIG. 26A to FIG. 26E, the value of modulation transfer function of the region R1 at a spatial frequency of 77 lp/mm is greater than 0.18, the value of modulation transfer function of the region R2 at a spatial frequency of 77 lp/mm is greater than 0.15, the value of modulation transfer function of the region R3 at a spatial frequency of 77 lp/mm is greater than 0.1, and the value of modulation transfer function of the region R4 at a spatial frequency of 77 lp/mm is greater than 0.05. The present lens assembly obviates imaging aberrations, achieving excellent imaging quality.

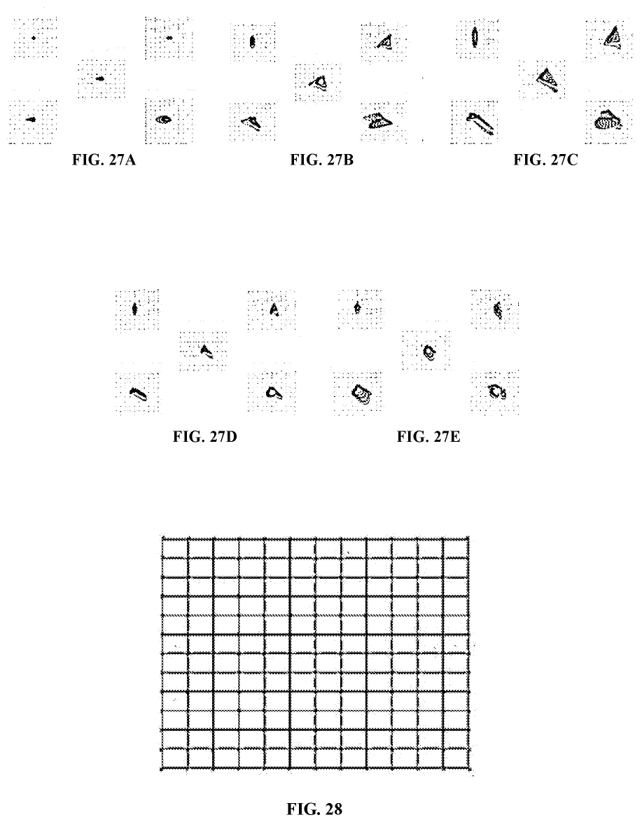

FIG. 27A to FIG. 27E are point-column diagrams of several regions for testing imaging quality of a lens assembly depicted in FIG. 23. Referring to FIG. 27A to FIG. 27E, the maximum RMS radius is below 12.28 μm, indicating a spot in an individual field of view is relatively small, imaging aberrations are well obviated, and the imaging quality of the lens assembly is excellent.

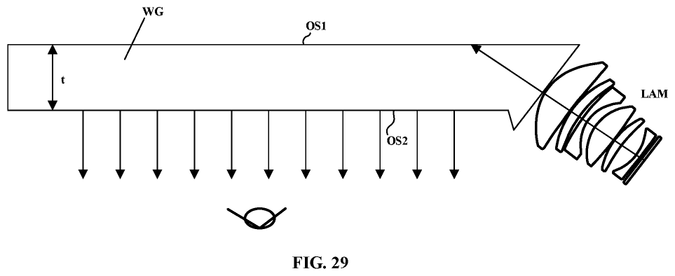

FIG. 28 shows aberrations of a lens assembly depicted in FIG. 23. Referring to FIG. 28, the maximum aberration of the lens assembly is 1.0%.

In some embodiments, at least an (N-3)-th lens is a biconvex lens (see, e.g., FIG. 1, FIG. 11, and FIG. 23).

In some embodiments, an (N-1)-th lens is a biconvex lens (see, e.g., FIG. 11).

In some embodiments, the N-th lens is a biconvex lens (see, e.g., FIG. 23).

In some embodiments, an (N-2) lens and an (N-4)-th lens are biconvex lenses (see, e.g., FIG. 17).

In some embodiments, at least the first lens is a biconcave lens (see, e.g., FIG. 1 and FIG. 17).

In one example, referring to FIG. 1, the first lens is a biconcave lens, an (N-3)-th lens is a biconvex lens, the N-th lens is a convex concave lens, an (N-1)-th lens is a convex concave lens, an (N-2)-th lens is a convex concave lens, and an (N-4)-th lens is a convex concave lens.

In another example, referring to FIG. 11, an (N-1)-th lens is a biconcave lens, an (N-3)-th lens is a biconcave lens, the N-th lens is a convex concave lens, an (N-2)-th lens is a convex concave lens, and the first lens is a convex concave lens.

In another example, referring to FIG. 17, the first lens is a biconcave lens, an (N-2)-th lens is a biconvex lens, an (N-4)-th lens is a biconvex lens, the N-th lens is a convex concave lens, an (N-1)-th lens is a convex concave lens, and an (N-3)-th lens is a convex concave lens.

In another example, referring to FIG. 23, the N-th lens is a biconvex lens, an (N-3)-th lens is a biconvex lens, an (N-1)-th lens is a convex concave lens, an (N-2)-th lens is a convex concave lens, and the first lens is a convex concave lens.

In some embodiments, the N-th lens has a first even aspheric surface (see, e.g., FIG. 1, FIG. 11, FIG. 17, and FIG. 23).

In some embodiments, the N-th lens has a first even aspheric surface but a second surface of the N-th lens opposite to the first even aspheric surface is not an even aspheric surface (see, e.g., FIG. 1).

In some embodiments, the N-th lens has a first even aspheric surface, and a second even aspheric surface opposite to the first even aspheric surface (see, e.g., FIG. 11, FIG. 17, and FIG. 23).

In some embodiments, at least one of two opposite surfaces of an (N-1)-th lens is an even aspheric surface (see, e.g., FIG. 17 and FIG. 23).

In some embodiments, at least one of two opposite surfaces of an (N-2)-th lens is an even aspheric surface (see, e.g., FIG. 11 and FIG. 23).

In some embodiments, at least one of two opposite surfaces of an (N-3)-th lens is an even aspheric surface (see, e.g., FIG. 23).

In one example, referring to FIG. 17, two opposite surfaces of the N-th lens and two opposite surfaces of an (N-1)-th lens are even aspheric surfaces.

In another example, referring to FIG. 11, two opposite surfaces of the N-th lens, two opposite surfaces of an (N-2)-th lens, and two opposite surfaces of an (N-4)-th lens are even aspheric surfaces.

In another example, referring to FIG. 23, two opposite surfaces of the N-th lens, two opposite surfaces of an (N-1)-th lens, two opposite surfaces of an (N-2)-th lens, and two opposite surfaces of an (N-3)-th lens are even aspheric surfaces.

In another aspect, the present disclosure provides an electronic device. In some embodiments, the electronic device includes the lens assembly described herein and a waveguide configured to receive the image light exited from the lens assembly. FIG. 29 is a schematic diagram illustrating the structure of an electronic device in some embodiments according to the present disclosure. Referring to FIG. 29, the electronic device in some embodiments includes a lens assembly LAM described herein and a waveguide WG. The lens assembly includes N number of lenses and a display panel. The N number of lenses are configured to receive image light from the display panel. The image light exits the lens assembly LAM and enters into the waveguide WG. The waveguide WG has a first opposing surface OS1 and a second opposing surface OS2 separated by a thickness t of the waveguide WG. The image light entered into the waveguide WG is configured to propagate along the waveguide WG by reflecting off of the first opposing surface OSI and the second opposing surface OS2 using total internal reflection.

Various appropriate display panels may be used in the lens assembly. Examples of display panels include a liquid crystal display panel, a light emitting diode display panel such as an organic light emitting diode display panel and a micro light emitting diode display panel.

In some embodiments, the electronic device is a head-mounted display apparatus.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A lens assembly, comprising N number of lenses;
wherein the N number of lenses comprises a first lens having a receiving surface configured to receive image light from a display panel and an N-th lens having an exit surface through which the image light exits, N≥2;
wherein, on a side where the image light exits the N-th lens, the N-th lens has a length and a width; and
a ratio of the length to the width is greater than 3:1.

2. The lens assembly of claim 1, wherein the exit surface is a first even aspheric surface.

3. The lens assembly of claim 2, wherein the first even aspheric surface satisfies the following function:
$$Z = \frac{{cr}^{2}}{1 + \sqrt{1 - ( k + 1 ) {c}^{2} {r}^{2}}} + {Σ}_{i} {A}_{2 i} {r}^{2 i} ;$$
wherein Z stands for a shortest distance between a respective point on the first even aspheric surface to a plane tangent to the first even aspheric surface at a vertex of the even aspheric surface;
c stands for a curvature of the even aspheric surface;
k stands for a quadratic surface coefficient;
r stands for a shortest distance between the respective point on the first even aspheric surface to an optical axis of the lens assembly; and
A₂ᵢ stands for a multiple term coefficient.

4. The lens assembly of claim 2, wherein the N-th lens has a second even aspheric surface opposite to the first even aspheric surface.

5. The lens assembly of claim 2, wherein at least one of two opposite surfaces of an (N-1)-th lens is an even aspheric surface.

6. The lens assembly of claim 2, wherein at least one of two opposite surfaces of an (N-2)-th lens is an even aspheric surface.

7. The lens assembly of claim 2, wherein at least one of two opposite surfaces of an (N-3)-th lens is an even aspheric surface.

8. The lens assembly of claim 1, wherein two opposite surfaces of the N-th lens and two opposite surfaces of an (N-1)-th lens are even aspheric surfaces.

9. The lens assembly of claim 1, wherein two opposite surfaces of the N-th lens, two opposite surfaces of an (N-2)-th lens, and two opposite surfaces of an (N-4)-th lens are even aspheric surfaces.

10. The lens assembly of claim 1, wherein two opposite surfaces of the N-th lens, two opposite surfaces of an (N-1)-th lens, two opposite surfaces of an (N-2)-th lens, and two opposite surfaces of an (N-3)-th lens are even aspheric surfaces.

11. The lens assembly of claim 1, wherein at least an (N-3)-th lens is a biconvex lens.

12. The lens assembly of 11, wherein an (N-1)-th lens is a biconvex lens.

13. The lens assembly of 11, wherein the N-th lens is a biconvex lens.

14. The lens assembly of claim 1, wherein an (N-2) lens and an (N-4)-th lens are biconvex lenses.

15. The lens assembly of claim 1, wherein at least the first lens is a biconcave lens.

16. The lens assembly of claim 1, wherein the first lens is a biconcave lens, an (N-3)-th lens is a biconvex lens, the N-th lens is a convex concave lens, an (N-1)-th lens is a convex concave lens, an (N-2)-th lens is a convex concave lens, and an (N-4)-th lens is a convex concave lens.

17. The lens assembly of claim 1, wherein an (N-1)-th lens is a biconcave lens, an (N-3)-th lens is a biconcave lens, the N-th lens is a convex concave lens, an (N-2)-th lens is a convex concave lens, and the first lens is a convex concave lens.

18. The lens assembly of claim 1, wherein the first lens is a biconcave lens, an (N-2)-th lens is a biconvex lens, an (N-4)-th lens is a biconvex lens, the N-th lens is a convex concave lens, an (N-1)-th lens is a convex concave lens, and an (N-3)-th lens is a convex concave lens.

19. The lens assembly of claim 1, wherein the N-th lens is a biconvex lens, an (N-3)-th lens is a biconvex lens, an (N-1)-th lens is a convex concave lens, an (N-2)-th lens is a convex concave lens, and the first lens is a convex concave lens.

20. An electronic device, comprising the lens assembly of claim 1, and a waveguide configured to receive the image light exited from the lens assembly.
